(19) United States
(12) Patent Application Publication
(10) Pub. No.: US 2002/0021573 A1
(43) Pub. Date: Feb. 21, 2002

(54) Lighting devices using LEDs

(76) Inventor: Evan Y. W. Zhang, Centerville, OH (US)

Correspondence Address: Bernard E. Franz, 180 Davis Ave., Enon, OH, 45323-1810, US

(21) Appl. No.: 09/973,554

(22) Filed: Oct. 9, 2001

Related U.S. Application Data
(60) Provisional application No. 60/201,832, filed on May 3, 2000.

(51) Int. Cl. F21V 7/04

(52) U.S. Cl. 362/555

(57) ABSTRACT

This invention uses LEDs to replace the incandescent bulbs for 5 lighting devices because the LED has much lower power consumption, much longer lifetime, and many other advantages than incandescent bulb.

The key of the invention of the 5-color LED flashlights is to put 5 LED filaments with 5 different colors into one LED bulb and uses 3 different designs to select different colors and give different signals, thus color filters and 2 minutes of preparing time for old flashlight activation are not necessary.

The key of the invention of the chip-on-board LED exit signs is to put LED chips (filaments) on the circuit board and drop epoxy on them to make wide angle LEDs, and coat a layer of high reflection material on the board to collect light, thus a chip-on-board LED exit sign with almost 180° very uniform illumination can be obtained. In comparison with the old incandescent exit sign of 40 watts and 3-month lifetime, this LED exit sign only has 5 watts and the lifetime is over 30 years. The energy and labor savings are remarkable.

The key of the invention of the LED lamps is to replace the 40-100 W and 3-month lifetime tungsten bulbs by 5-15 W and 30-year lifetime LED bulbs to get a large amount of energy and labor savings.

The key of the invention of the LED traffic lights is to make a bowl-shape LED lamp with circuit board inside the bowl and having plastic magnifier with UV and IR protection coating to cover the bowl. By screwing out the old 100-W and 3-month lifetime incandescent lamp and screwing in this 10-W and 30-year lifetime LED lamp, the job is done. Since LEDs have different colors, red, yellow and green filters are not necessary to use, the efficiency is much higher. The invention also has a battery backup circuit to prevent traffic jam and accident during power interruption.

The key of the invention of the parabolic LED is put the LED chip (filament) on the focal point of the parabolic reflector thus it collects all of the light created by the chip and project the light to a long distance similar to a search light. In comparison with the common LED, the parabolic LED has at least 5 times higher intensity and 10 times longer distance.

### STATEMENT

This invention is related to our previous provisional patent application “Products Using Light Emitting Diodes” filed on Jun. 12, 2000 under application Ser. No. 60/201,832. A copy of the provisional application including enclosures therewith is enclosed herewith and made a part hereof as thought fully set forth.

### BACKGROUND OF THE INVENTION

This invention relates to 5 lighting devices using Light Emitting Diodes (LEDs): 5-color LED flashlights, chip-on-board LED exit signs, LED traffic lights, LED lamps, and parabolic LEDs. Following is the background of this invention:

Background of the 5-color Flashlights

In this world it doesn't matter which country, every soldier of every country must have a 5-color (red, yellow, green, blue, and white) for map reading and emergent communication. The current flashlight uses white tungsten bulb and color filters. If the soldier wants to use the flashlight with desired color, he must screw out the tail cover of the flashlight, take out one color filter, and put the tail cover back. Then he must screw out the head cover, put the filter in, and screw the head cover back to the flashlight. It will spend him at least 2 minutes. During the combat, he probably will be killed in these 2 minutes and the combat probably will be over. In addition, the filters are not only expensive but also easy to be dropped down on the ground during the night and can not find them again. Besides, the power consumption of the tungsten bulb is high and its lifetime is short. This invention is to overcome above problems.

Background of the Chip-on-board LED Exit Signs

Old Exit Signs use two incandescent lamps of 20 W each, the power consumption is high, the efficiency is low, and the lifetime is short. The bulbs will be burned within several months and the building owner must let a certified electrician to replace them that will cost him $30 for the labor. In order to overcome these shortcomings, LED Exit Signs were created. However, these Exit Signs use common LEDs. Not only the Exit Sign light is not uniform (the light consists of many dots), but also it is more expensive because we must take many steps to make a LED then put it on the Exit Sign board. In order to overcome these problems, a new LED Exit Sign should be invented.

Background of the LED Lamps

Conventional 40-150 W house bulbs are incandescent bulbs, their lifetimes are short, utilities are high, efficiencies are low, and replacements are often. If we can use LEDs to make lamps, all above problems can be solved.

During road construction, at least two workers holding flags must stand on both sides of the road to conduct the traffic. Because of signal confusion, some times traffic jam even accident happens. During the highway accident, many policemen must stand by the accident area and put many flares on the ground. The flares can only last short time, and the drivers are hard to see them. Traffic jam becomes a serious problem. If we can use a tripod or a magnetic pod attaching on the car to put small red and green LED traffic lights powered by battery on the constructing road or highway, flag workers, flares and some policemen can be withdrawn. Dramatic material and labor savings can be achieved. Traffic jams and accidents can be largely eliminated.

Background of the LED Traffic Lights

Current traffic lights use 67-120 W white incandescent lamps with red, yellow and green filters. A large amount of energy is wasted because the red, yellow and green filters are narrow band filters; they only allow 15% of the white light to pass. Besides, the lifetime of the incandescent lamp is only 3 months. If there is a lamp-blow or power failure, to solve the problem will cost a few hundred dollars. Actually, the costs of the traffic jam and accident during lamp-blow or power interruption are far beyond the above labor cost.

Several companies have proposed to use LED for traffic lights, but no one is successful because (1) the UV radiation of the sun will accelerate the LED plastic head aging quickly, (2) the cumulated heat in the enclosure created by the IR radiation of the sun will reduce the brightness of the LED quickly, (3) the intensity of common LED is too low and the illumination distance is too short thus a large amount of LEDs (about 200) are required that is unacceptable, (4) to light the LED, their designs need a transformer, or several capacitors and resistors to reduce the power from 120 V AC to 4 V DC; the size of the transformer is too big to make a retro-fit-kit, and the configuration of using capacitors and resistors has low power factor and high harmonic distortion that is unacceptable, (6) the lifetime of current LED traffic light is only 10 years not 30 years, (7) there is no battery back up during power interruption, traffic jams and accidents occur, (8) current LED traffic lights can not pass the conflict monitor testing, (9) to change the incandescent lamp to LED lamp, the worker must disconnect the power line and take off the reflector and lens cover, it is time consuming and costly, (10) the costs of the LED traffic lights are too high (over $150 per color lamp or $450 per red, yellow, and green set).

The purpose of this invention is to overcome all above problems.

Background of the Parabolic LED

Since a Light Emitting Diode (LED) is not a laser diode, it is impossible to directly get a collimating beam. The minimum divergent angle of a LED at current time is at least ±20°, and a lot of light is wasted in the back propagation direction. Therefore, the intensity is too low and the illuminating distance is too short (a few meters). This prevents it to be used for many important applications. In order to overcome these shortcomings, a parabolic LED is invented.

### SUMMARY OF THE INVENTION

This invention uses LEDs to replace the incandescent bulbs for 5 lighting devices because the LED has much lower power consumption, much longer lifetime, and many other advantages than incandescent bulb.

The key of the invention of the 5-color LED flashlights is to put 5 LED filaments with 5 different colors into one LED bulb and uses 3 different designs to select different colors and give different signals, thus color filters and 2 minutes of preparing time for old flashlight activation are not necessary.

The key of the invention of the chip-on-board LED exit signs is to put LED chips (filaments) on the circuit board and drop epoxy on them to make wide angle LEDs, and coat a layer of high reflection material on the board to collect light, thus a chip-on-board LED exit sign with almost 180° very uniform illumination can be obtained. In comparison with the old incandescent exit sign of 40 watts and 3-month lifetime, this LED exit sign only has 5 watts and the lifetime is over 30 years. The energy and labor savings are remarkable.

The key of the invention of the LED lamps is to replace the 40-100 W and 3-month lifetime tungsten bulbs by 5-15 W and 30-year lifetime LED bulbs to get a large amount of energy and labor savings.

The key of the invention of the LED traffic lights is to make a bowl-shape LED lamp with circuit board inside the bowl and having plastic magnifier with UV and IR protection coating to cover the bowl. By screwing out the old 100-W and 3-month lifetime incandescent lamp and screwing in this 10-W and 30-year lifetime LED lamp, the job is done. Since LEDs have different colors, red, yellow and green filters are not necessary to use, the efficiency is much higher. The invention also has a battery backup circuit to prevent traffic jam and accident during power interruption.

The key of the invention of the parabolic LED is put the LED chip (filament) on the focal point of the parabolic reflector thus it collects all of the light created by the chip and project the light to a long distance similar to a search light. In comparison with the common LED, the parabolic LED has at least 5 times higher intensity and 10 times longer distance.

### Features

The claims for 5 lighting devices using LEDs are as follows:

1. The featuress for 5-color LED Flashlights

(a) Use LEDs for flashlights.

(b) Use different color LEDs to eliminate the color filters.

(c) Put red, yellow, green, blue, and white LED chips (filaments) into one bulb, and connect them to an IC, or a rotational switch, or 5 buttons.

(d) Use a IC related button for color (chip) selection and another button for signaling.

(e) Use rotational head or rotational switch for color selection and another button for signaling.

(f) Use 5 buttons for color selection and signaling.

(g) The button has 3 positions: push to the upper position to hold light, push to the middle position to select color or give signal, nad push to the lower position to shut down the power.

(h) The LED flashlight only uses ⅕ of the tungsten flashlight power and has a lifetime of 30 years.

2. The Features for Chip-on-board LED Exit Signs

(a) Use LEDs with different colors for Exit Signs.

(b) Put LED chips and epoxy drops directly on the circuit board to make wide angle LEDs, and coat a reflection layer on the board to collect the back forward light. These make the Exit Sign very uniform, very bright, and inexpensive.

(c) This uniform chip-on-board LED light can be used as back light for many applications.

(d) The circuit design allows the LED board to use 120 VAC or 220 VAC line power and charge the battery. During power interruption, the battery becomes the power supply for the LED board.

(e) There are n LEDs in serial on one row and m rows in parallel on the board. If several LEDs or rows are damaged, the Exit Sign (or the back light) will be still lighted uniformly.

(f) The LED board thus the Exit Sign can be single face or double face.

(i) The LED Exit Sign (or back light) only uses 1/10 of the tungsten Exit Sign power and has a lifetime of 30 years.

3. The Features for LED Lamps

(a) Use LEDs with different colors to make lamps.

(b) The lamp has bowl shape with LEDs on the face and electronic circuit board inside the bowl. The bowl has or does not have a transparent or diffused cover.

(c) The circuit board can use transformer, switching power supply, or resistor and capacitor to reduce the voltage and change the AC power to DC power.

(d) The lamp has common screw type head to be screwed into the common socket with AC or DC power supply.

(g) There are n LEDs in serial on one row and m rows in parallel on the LED lamp panel. If several LEDs or rows are damaged, the lamp will be still lighted properly.

(e) The LED lamp only uses ⅕ of the equivalent incandescent lamp power and has a lifetime of 30 years.

4. The Features for LED Traffic Lights

(a) Use red, yellow, and green LEDs for traffic lights.

(b) The traffic light lamp has bowl shape with LEDs on the face and electronic power circuit board inside the bowl. The bowl has a plastic magnifier cover with LV and IR coatings to let the LED light fulfill the enclosure cover lens and filter out the UV and IR radiation from the sun.

(c) The power circuit is a switching power circuit that has high power factor, low harmonic distortion and large voltage fluctuation tolerance.

(d) The LED lamp has common screw type head to be screwed into the traffic light socket with AC power supply. By screwing out the old incandescent lamps and screwing in the LED lamps, the job is done. Other parts still can be used. It gives a large amount of material and labor savings, and the line power is not necessary to be shut down during installation.

(h) There are n LEDs in serial on one row and m rows in parallel on the LED lamp panel. If several LEDs or rows are damaged, the lamp will be still lighted uniformly and is able to pass the conflict monitor testing.

(i) The LED lamp only uses ⅛ of the power of the equivalent incandescent lamp with color filter and has a lifetime of 30 years. Therefore, large energy and labor savings are achieved.

(j) In normal situation, the circuit will charge the battery. If the power is interrupted, the battery becomes the power supply of the LED traffic lights. Therefore, the traffic jams and accidents can be avoided.

4. The Features for Parabolic LEDs and Combination LEDs

(a) The LED chip is at the focal point of the parabolic reflector with diameter of several or several ten millimeters, thus 5 times higher intensity and 10 times longer illuminating distance than common LED can be realized.

(b) The LED chip is covered by epoxy. Two legs are connected to the DC power supply or battery.

(c) Different color chips will be used.

(d) By putting the chip not exactly on the focal point, the divergent angle of the LED beam can be changed.

(e) Two different LED chips (such as visible and invisible) can be combined together back by back and put into one epoxy head. By properly connecting them to a battery and using a switch, two LEDs can be lighted alternatively.

(f) By using several or several ten parabolic LEDs, we can make a LED search light.

### BRIEF DESCRIPTION OF SEVERAL VIEWS OF THE DRAWING

The following detailed description of the preferred embodiments of the present invention can be best understood when read in conjunction with the following drawings, where like structure is indicated with like reference numbers, and in which:

FIGS. 1.1 to 1.6 are drawings for 5-color LED flashlight. FIG. 1.1 is the mechanic diagram of the color selecting IC design. FIG. 1.2 is the electronic diagram of the color selecting IC design. FIG. 1.3 is the electronic diagram of the rotational switch design. FIG. 1.4 is the mechanic diagram of the rotational switch design. FIG. 1.5 the mechanic diagram of the five-button design. FIG. 1.6 is the electronic diagram of the five-button design.

FIG. 2.1 is the electronic diagram of the chip-on-board LED Exit Sign with battery backup.

FIG. 3.1 is the structure diagram of the LED lamp.

FIG. 4.1 is the structure diagram of the bowl-shape LED Retro-fit-kit lamp for traffic lights. FIG. 4.2 is the visible waveband filter for traffic lights.

FIG. 5.1 is the diagram of the common LED. FIG. 5.2 is the configuration of the parabolic LED. FIG. 5.3 is the combination design of the visible and invisible Leds.

### DETAILED DESCRIPTION OF THE PREFERRED EMBODIMENTS

In the following detailed description of the preferred embodiments, reference is made to the accompanying drawings mentioned above.

1. Preferred Embodiment for 5-color LED Flashlights

It is well known that the intensity of Light Emitting Diode (LED) has already reached several Candles (CDs). It is comparable with the intensity of current flashlight using tungsten bulb with filters. Besides, different LEDs with different wavelengths have different colors, so color filters are not necessary to use. If we can use LED bulb to replace the tungsten bulb, all problems mentioned above can be solved. The key technology is how can we put 5 LEDs in one bulb and how can we use one button to activate them. Following are our three innovative designs:

(a) Using a Control Chip

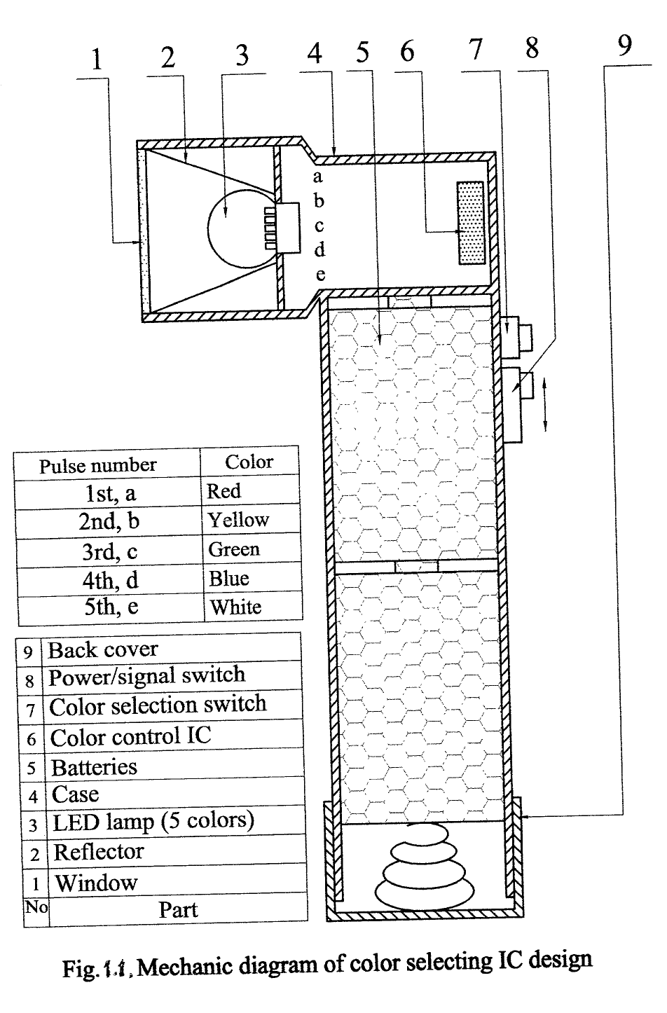

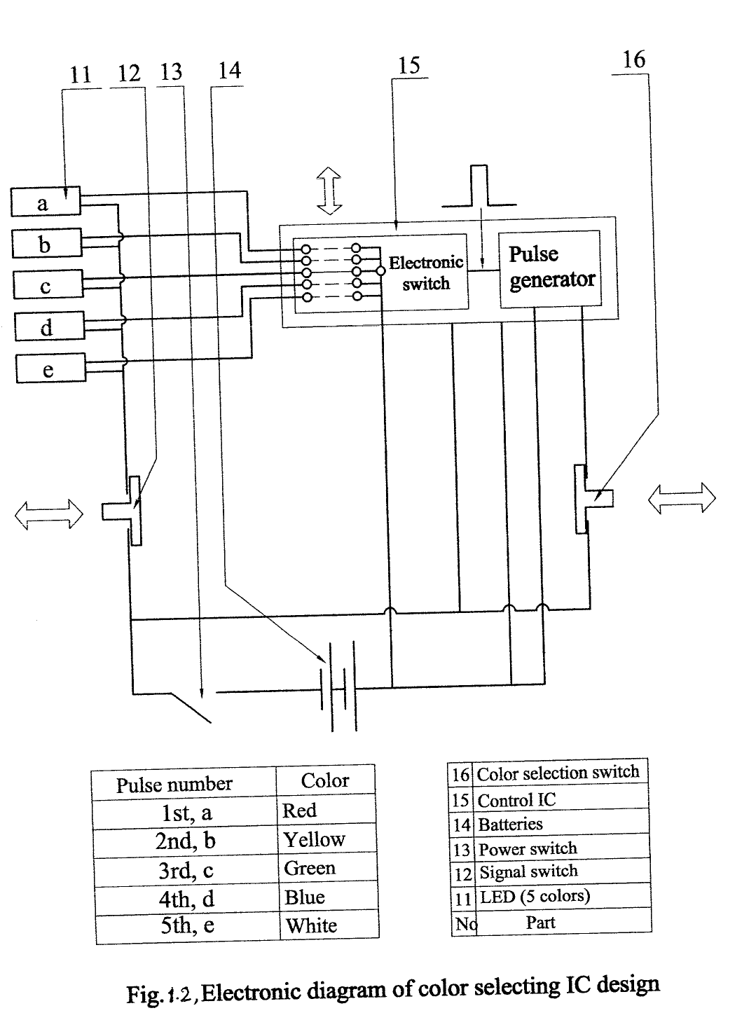

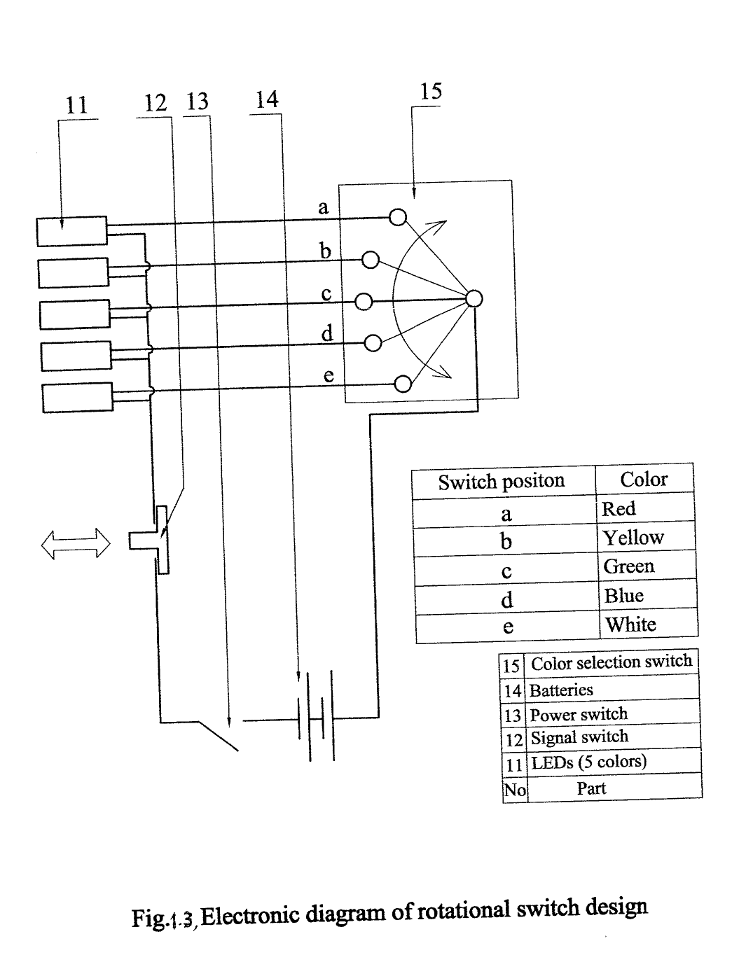

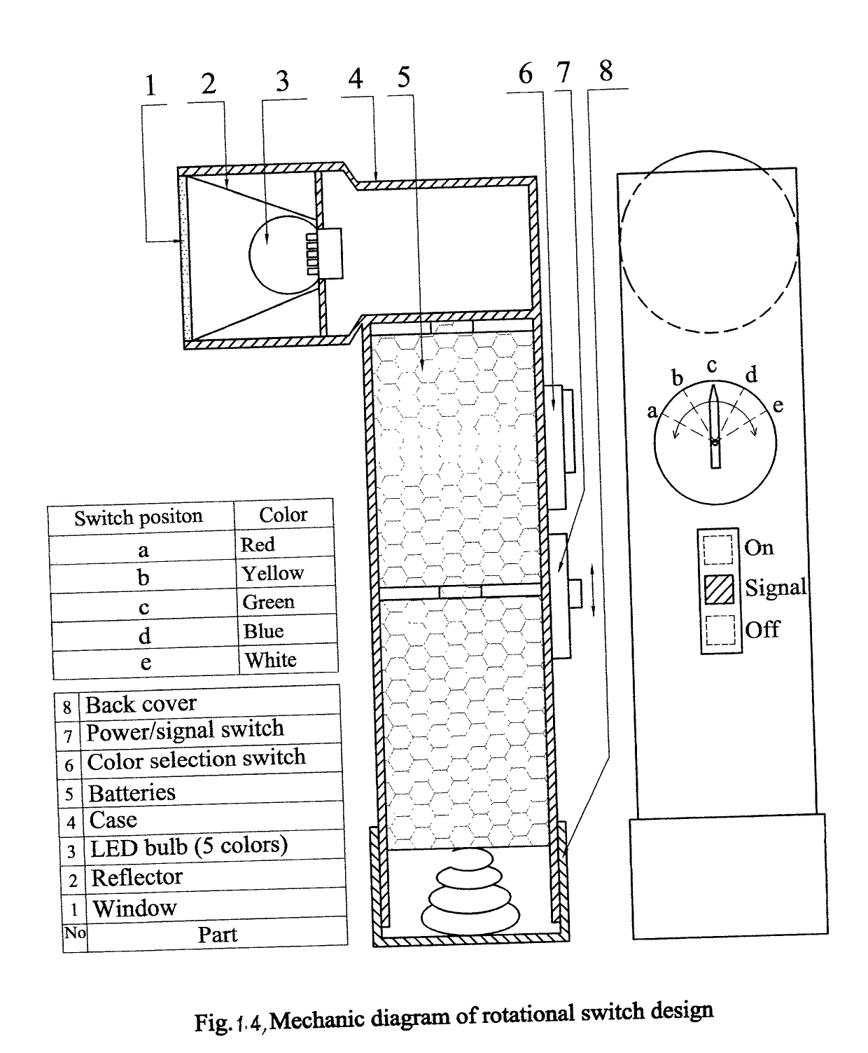

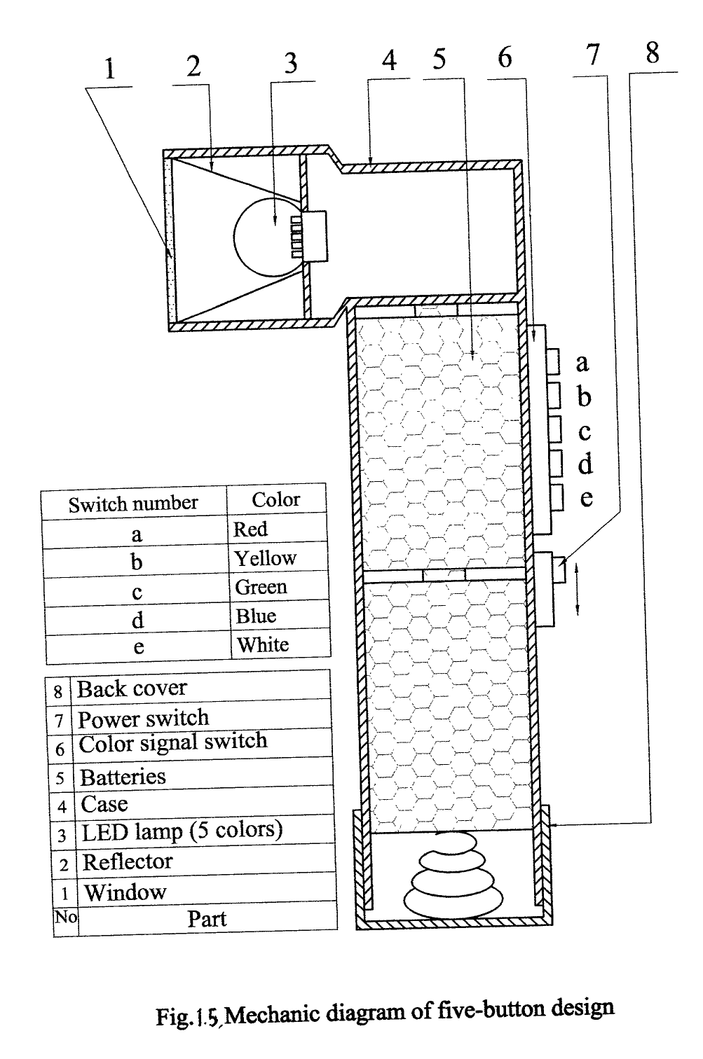

It is impossible to put 5 LEDs inside a small bulb. However, as shown in FIG. 1.1, we can put 5 filaments a, b, c, d, an e inside the bulb 3 because the filament is only a few microns. The 5 filaments will be put around the focal point of the flashlight reflector 2 and linked with a specially designed Integrated Circuit (IC) chip 6 for switching. As shown in FIG. 1.2, the chip will connect to the right button 16 (in FIG. 1.1 is 7) that selects the LED color electronically. By clicking the button once at the first time, the red filament will be connected to the power and a low-intensity red LED indicator on the flashlight will be lighted. There is another button 12 including 13 on the left side. The soldier can use this button to give the red signals (long-short-long, etc.). By clicking the right button once at the second time, the yellow filament will be connected to the power, the soldier can use the left button to give the yellow signals. By clicking the right button once at the third time, fourth time and fifth time, the soldier can get the green, blue, and white colors and use the left button to give corresponding color signals. Similar to the current flash light, the left button 12 including 13 (in FIG. 1.1 is 8) has 3 positions: the middle position is to select the color light, the forward (upper) position is to hold the color light, and the backward (lower) position is to shut down the power. The only difference is that we need a left button at the middle position to help the right button to give signals. The operation procedures are: use the right button to select the desired color then push the left button to the middle position to give signals; if the soldier hopes to read the map hands free, he can push the left button to the upper position; if he wishes to shut down the flash light, he can push the left button to the lower position.

(b) Using a Rotational Head or a Rotational Switch

The second approach is to use a rotational flashlight head or switch. As shown in FIG. 1.3, all positive wires of 5 LED filaments are linking to the positive pole of the battery. Five negative wires of 5 filaments are welded to 5 copper female contacts (#a, #b, #c, #d, and #e) on a ring 15 at the inner surface of the flashlight head. These contacts are separated by plastic insulators and have the corresponding color indicators or low-intensity color LEDs. The flashlight head can be rotated relative to the flashlight body. There is a male contact with spring on the body and under the female contacts. This male contact is linked with a wire from the signaling button of the body. When the head is rotated to position #a, the female contact #a will connect with the male contact and the spring will engage them firmly. Therefore, the user can use the control button 12 on the body to give red signals (such as long-short-short-long, etc.). When the head is rotated to position #b, the female contact #b will connect with the male contact, and the user can give yellow signals, and so on. As shown in FIG. 1.4, the control button 12 including 13 is as same as the button on the current flashlight. There are three positions: pushing the button to the upper position to lock the light for map reading and other hands-free operations, positioning the button at the middle position to give signals, and pulling the button to the lower position to shut down the power.

Instead of using rotational head, as shown in FIGS. 1.3 and 1.4, we also can use a rotational switch 15 (in FIG. 1.4 is 6) to select colors and use the control button 12 including 13 (in FIG. 1.4 is 7) to give signals and control the power.

(c) Using 5 Buttons

As shown in FIGS. 1.5 and 1.6, the third approach is a straight forward method to link 5 filaments a, b, c, d, and e with five buttons 6 (in FIG. 1.6 is 14) for signaling. These buttons indicated by different colors or low intensity color LEDs can be on a straight line or on a ring on the flashlight body. There is an extra button 7 (in FIG. 1.6 is 12) with two positions to hold the light or shut down the power.

This kind LED flashlight only uses ⅕ of the tungsten bulb power and has a lifetime of 30 years. Because it does not need color filters, it not only reduce the cost to half of the current flashlight but also the soldier can save 2 minutes of critical time during the combat (save time is save life). Obviously, this kind 5-color LED flashlight will be the dream item for soldiers in every country, and the market will be world wide.

2. Preferred Embodiment for Chip-on-board LED Exit Signs

(a) Chip-on-board LED Design

The first step is to make an electronic board with many positive and negative poles for LED chips (filaments). The second step is to coat a layer of high reflection material on the top of the board except the poles. The third step is to weld the LED filaments on the poles. The last step is to put a drop of epoxy on the LED filament to make a wide angle LED and prevent oxidizing. Because of the wide angle nature of the chip-on-board LED and the light reflected from the reflection layer, the viewing angle of the COBLEDES can reach almost 180 degrees and the uniformity is over 95%. Much less LEDs are required than using common LEDs, and the procedure of making this kind COBLEDES is mush simpler. Therefore, the cost of the Exit Sign is reduced but the quality of the light is improved.

(b) Electronic Circuit Board with Battery Backup Design

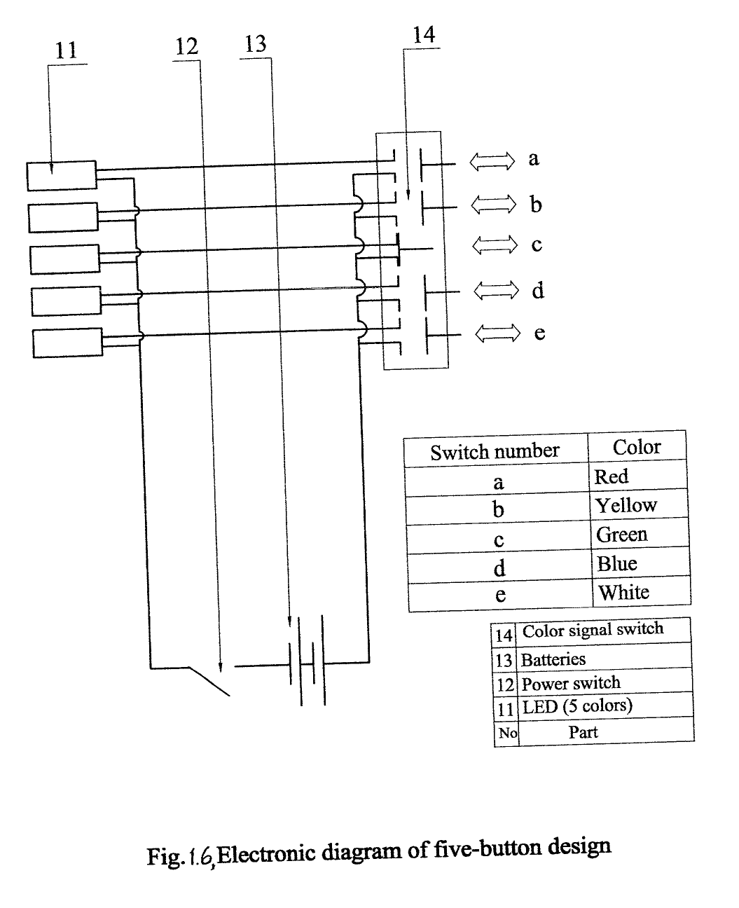

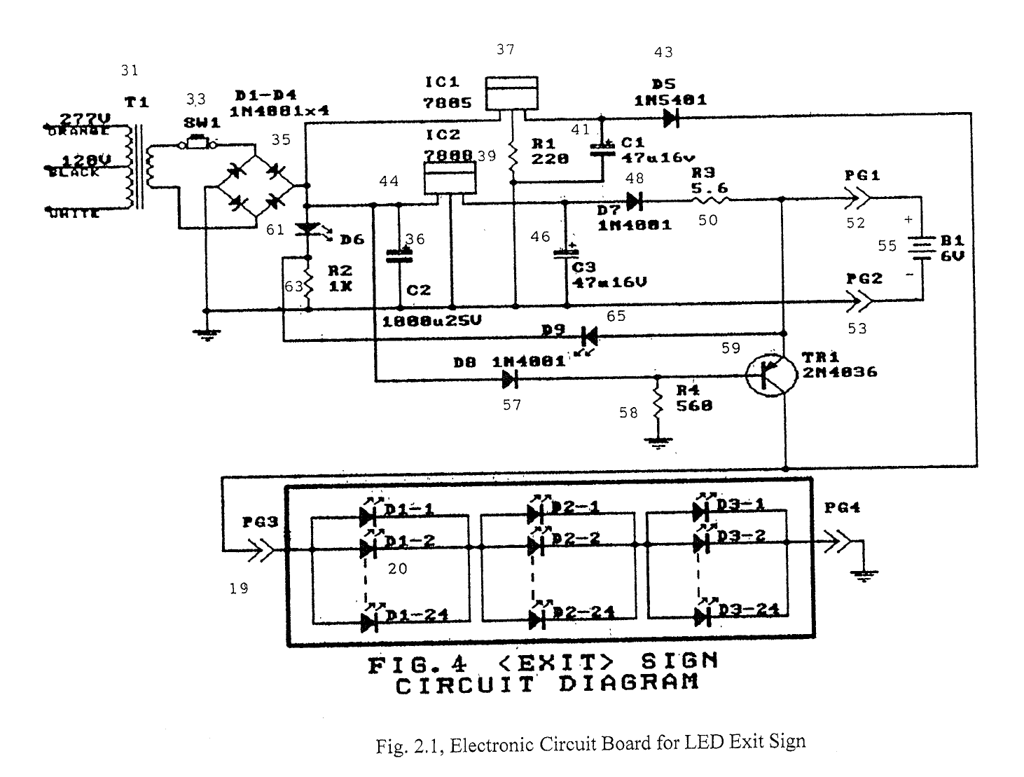

The circuit board design is shown in FIG. 2.1. The 120 VAC or 220 VAC power from the commercial line is reduced to 9 VAC by the transformer 31 and sent to the test switch 33. By pushing down the switch, the bridge rectifier 35 is disconnected with the line power supply and the COBLEDES 19 is powered by battery 55. From the light intensity we will know that if the battery should be replaced by a new one.

After filtering by the capacitor 36, the first output of the DC power from the rectifier 35 is sent to the regulator 37 of 5 VDC. The regulator connects to the ground through resister 39. After filtering by capacitor 41, the output of the regulator lights the COBLEDES 19 through diode 43. By adjusting the value of resister 39, the required voltage for COBLEDES 19 can be obtained.

After filtering by capacitor 36, the second output of the DC power from the rectifier 35 is sent to the regulator 44 of 8 VDC. After filtering by capacitor 46, this output is sent to the diode 48 and current limiting resister 50, then it charges the battery 55 through connectors 52 and 53.

The third output of the DC power from the rectifier 35 applies a reverse positive voltage to the EB node of the PNP transistor 59 through diode 57 and resister 58, thus the transistor is stopped. This is able to prevent the battery 55 to light the COBLEDES 19 if the line power is not interrupted.

When the line power is interrupted, diodes 43, 48 and 57 will be stopped. The fourth output from the rectifier 35 through indicating LED 61 has no current, thus it will not be lighted. At this time, the indicating LED 65 will be lighted through resistor 63, and the negative pole (connecting to the ground) of the battery 55 will apply a negative voltage to the base of the PNP transistor 59 through resistor 58. By adjusting the value of resistor 58, proper normal negative bias for the EB node of the PNP transistor 59 can be obtained so the transistor becomes conductive. In this case the battery 55 becomes the power supply of the COBLEDES 19.

The COBLEDES 19 has n LEDs is one row and m lows in parallel. Therefore, if several LEDs or several lows are damaged, it will not seriously affect the intensity and uniformity of the COBLEDES 19, because the wide-angle lights from other rows and the lights reflected from the reflector will contribute to the COBLEDES 19. However, if the Exit Sign uses common LEDs, its intensity and uniformity will be seriously affected.

(c) Chip-on-board Back Lights Design

Because the chip-on-board LED lights with red, yellow, orange, green, blue and white colors are very uniform, thus they are ideal back lights for automobile dash boards, advertisement lamp boxes in mall and bar, Liquid Crystal Display, 2-D and 3-D photo illuminations, and many other applications.

3. Preferred Embodiment for LED Lamps

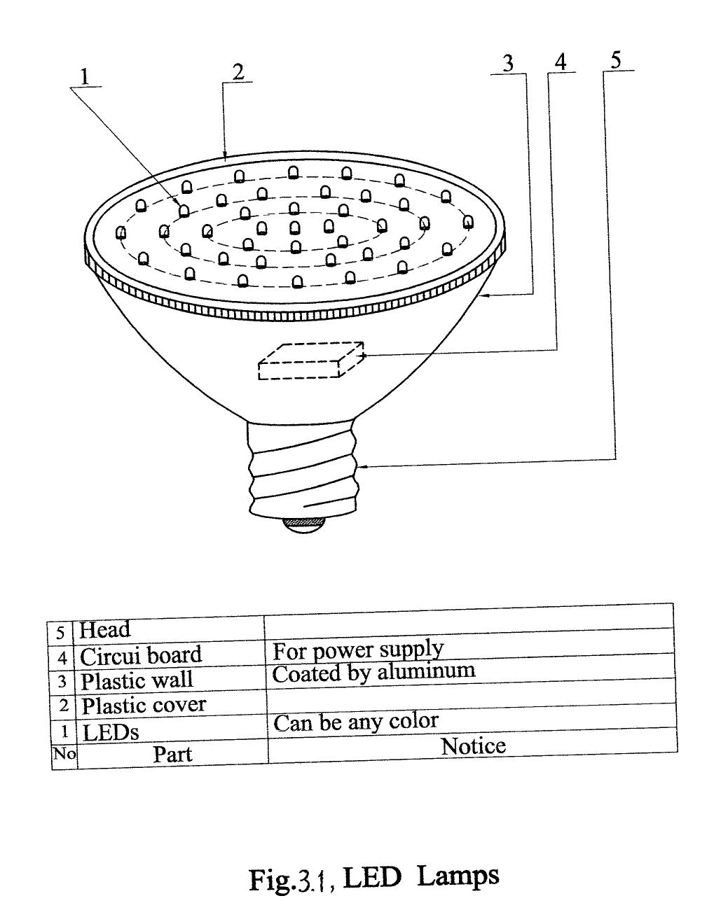

As shown in FIG. 3.1, the bowl-shape LED lamp consists of a screw type head 5 to be screwed into the AC or DC power socket, an aluminum coated plastic bowl 3 to be used as the heat sink for the circuit board, an LED panel 1 on the top with n LEDs in one row and m rows in parallel to be used as the light source thus several LEDs even several rows of LEDs damaging will not seriously affect the brightness of the lamp, an electronic circuit board 4 underneath the panel and inside the bowl, and a transparent or diffused plastic cover 2. Therefore, everything is inside the LED lamp. By screwing in the LED lamp into the socket and connecting with the AC or DC power, an LED lamp is lighted.

Since LED lamp uses DC power, for house LED lamps there are three ways to convert the AC power to DC power: (1) use transformer, it has high power factor, low harmonic distortion, long lifetime, medium voltage fluctuation tolerance, and medium cost, but the size is too big to be inserted into the bowl. (2) use transistors and capacitors; this method has small size and low cost, but the power factor is low, the harmonic distortion is high, the voltage fluctuation tolerance is small, and the lifetime is short. (3) use switching power supply; it has high power factor, low harmonic distortion, large voltage fluctuation tolerance, medium lifetime, medium size, but the circuit is more complicated and the cost is higher than others.

For road use LED lamps, we can use battery power. By properly link LEDs in serial and parallel, transformer and electronic circuit are not necessary to use.

Since the LEDs have different colors, we can use red, yellow, orange, green, and blue LEDs to make corresponding color lamps. For white LED, we must put a layer of fluorescent material on the blue LED to create the white fluorescent light. Because of high efficiency, a 5-W LED lamp is equivalent to a 25-W incandescent lamp. Large energy saving can be achieved. Besides, the lifetime of LED lamp is at least 30 years but the lifetime of the incandescent lamp is only a few months. The LED lamps have many military and commercial applications.

4. Preferred Embodiment for LED Traffic Lights

All current LED traffic lights designs have an LED panel, an electronic board, and a Fresnel lens with lens cover. The user must cut off the power line, take off the lamp and its socket, remove the reflector, and take off the cover lens, then install the LED panel, electronic board, Fresnel lens, and lens cover. It is time consuming and costly. In addition, he has to take the risk to connect the power line if the power is not off. By using our new invention, the user only needs to screw out the old incandescent bulb and screw in our LED retro-fit-kit bulb, in a few seconds the job is done. The traffic is almost not interrupted during the installation. It not only gives the user great convenience but also brings remarkable material and labor savings.

(a) LED Design

In order to get high intensity, we can make large LED filament. It needs special semiconductor processing and special equipment. The cost is high. A simple and economic way is to weld two or three LED filaments together in parallel, and then put a drop of epoxy to make a big LED. This LED will allow much larger current to pass. High brightness is realized.

(b) LED Lamp Design

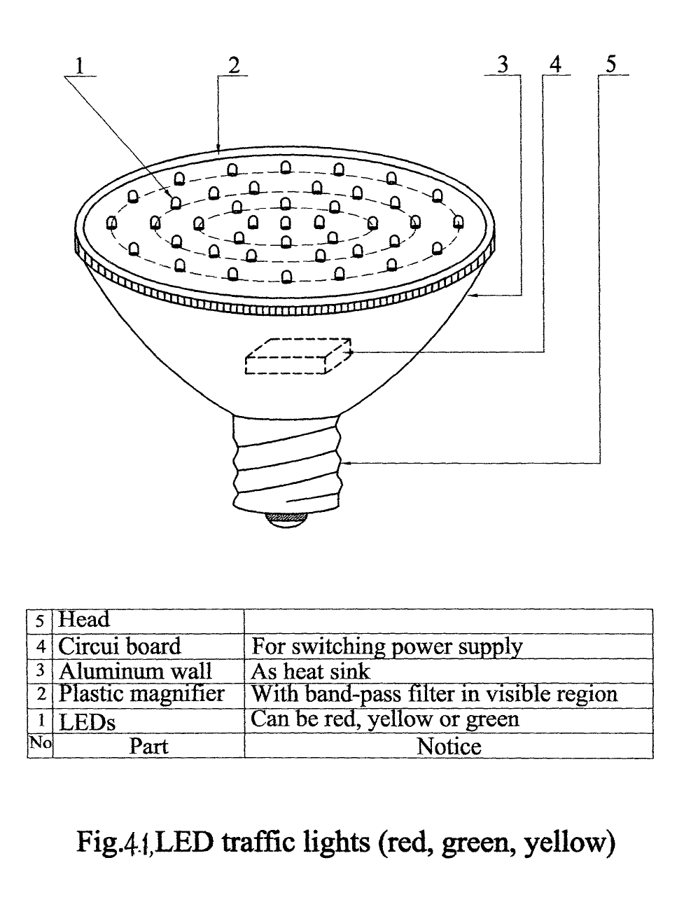

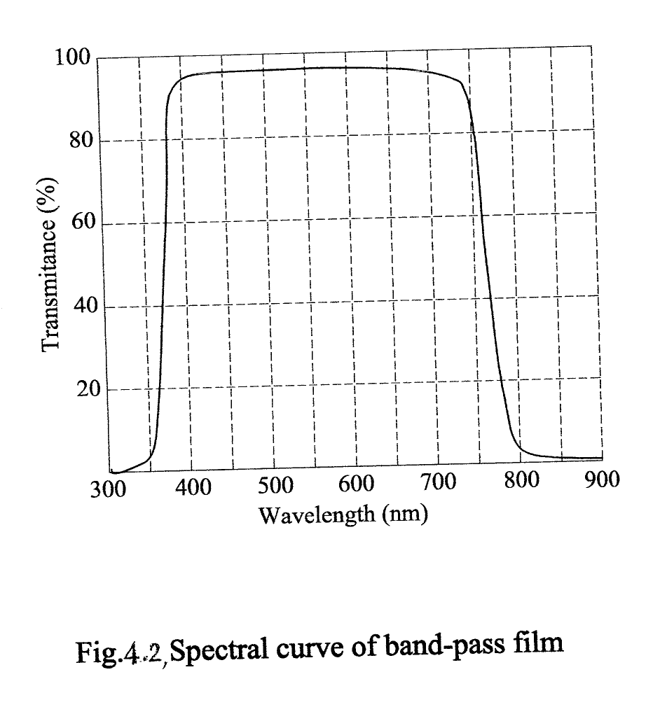

As shown in FIG. 4.1, the bowl-shape LED lamp consists of a screw type head 5 to be screwed into the AC power socket, an aluminum bowl 3 to be used as the heat sink for the circuit board, a LED panel 1 on the top with n LEDs in one row and m rows in parallel to be used as the light source thus several LEDs even several rows of LEDs damaging will not seriously affect the brightness of the lamp, an electronic circuit board 4 underneath the panel and inside the bowl, and a plastic magnifier cover 2 with visible band pass filter shown in FIG. 4.2. The LED can be parabolic LED (see this patent application for Parabolic LED) or common LED. Therefore, everything is inside the LED lamp. By screwing out the incandescent lamp and screwing in the LED lamp, the new LED traffic light is established.

(c) Electronic Board Design

In order to get high power factor and low harmonic distortion, a switching power supply board is designed. The switching power supply also allows large power voltage fluctuation (such as from 80 VAC to 260 VAC) without too much LED intensity change. This function is very important because usually when the voltage changes 10%, the LED output will be changed largely even the LED will be damaged. Of course, we also can use transformer or resistors and capacitors to reduce the voltage, the switching power supply is preferred.

(d) Waveband Filter Design

As mentioned before, the UV radiation of the sun will accelerate the LED plastic head aging quickly, and the IR radiation of the sun will heat the LED and reduce the brightness of the LED quickly. In order to solve these problems, as shown in FIG. 4.2, a waveband filter limited in the visible region is designed and coated on the LED panel surface. The filter consists of a short wavelength cut off filter at 0.38μ and a long wavelength cut off filter at 0.76μ, therefore, both UV and IR radiation can not get into the LED lamp.

(e) Plastic Magnifier Design

Since the LED lamp is small, a plastic magnifier 2 as a bowl cover is designed to enlarge the LED light and fulfill the cover lens of the enclosure. Because the existing color cover lens of the enclosure will absorb large amount of LED light, if the intensity of the LED lamp is not high enough, the color cover lens should be replaced by a transparent cover lens.

(f) Battery Backup Design

Because the power consumption of per LED color lamp is only 10 W not 120 W, thus it is possible to use a 12 VDC car battery as battery backup during power interruption. The traffic jam and accident can be largely reduced. A circuit board is designed (similar to FIG. 2.1). In normal situation, the 120 VAC power will charge the 12 VDC battery. When the power is interrupted, an inverter will change the 12 VDC power to 120 VAC power for control signal and LED lamp use. One battery can serve several intersections for several hours to get enough time for power restoration.

(g) Remote Control for Emergent Vehicles

A remote control and its corresponding circuit on the LED traffic lights are designed for emergent vehicles (such as police car and ambulance). When the remote control is activated, the light will turn to green for these vehicles and turn to red for other directions immediately. Therefore, terrible accident can be avoided.

5. Preferred Embodiment for Parabolic LEDs

(a) Parabolic LED

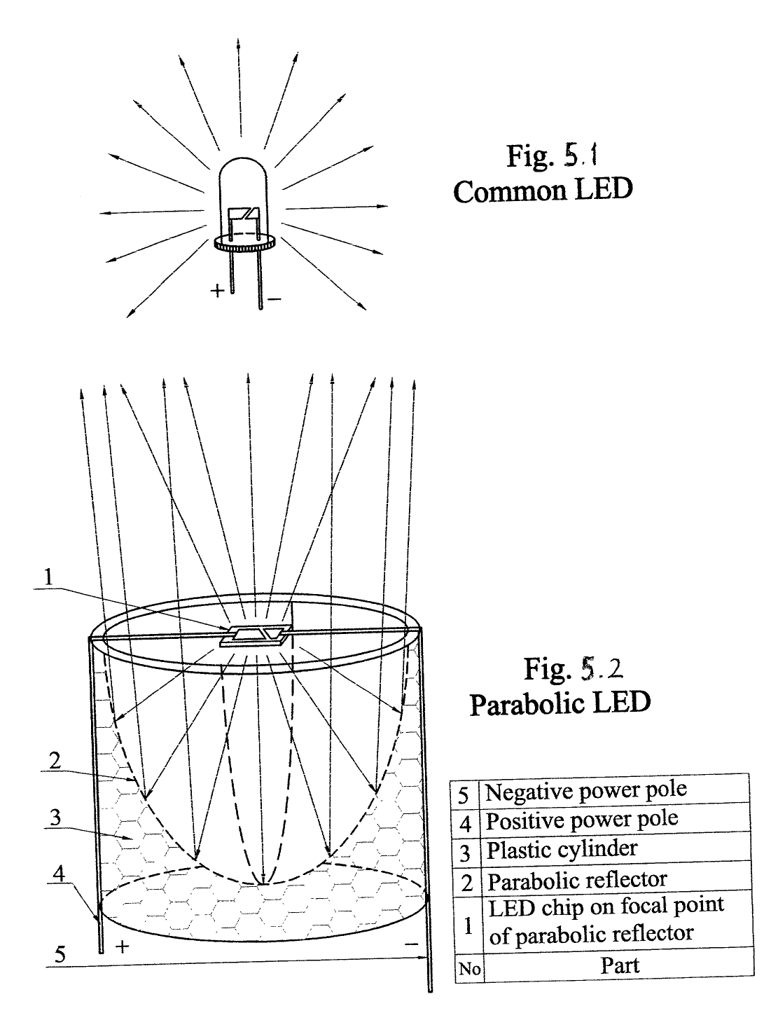

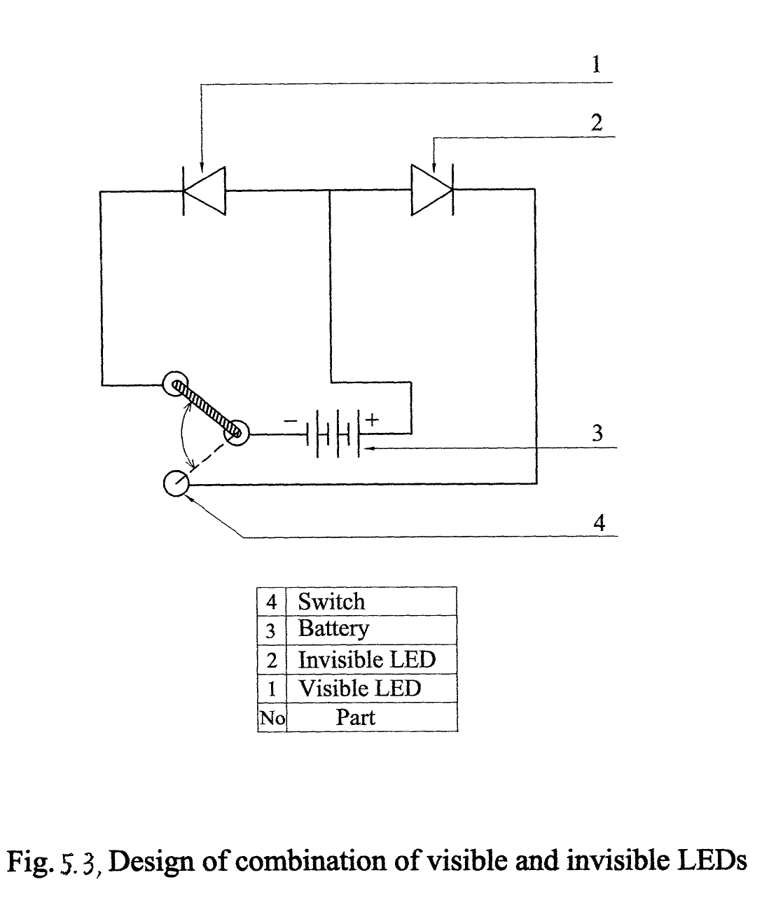

As shown in FIG. 5.2, the structure and the procedure of making a parabolic LED are as follows:

First, we have to make a convex parabolic male model about 12-20 mm, than stamp it into a piece of heated plastic sheet to make a female concave parabolic reflector 2. A thin layer of aluminum is coated by vacuum coating method to increase the reflectance. Two r-shape legs 4 and 5 for DC power supply (+and −) are glued on the outer surface or inner surface of the parabolic cylinder 3. By using special tool, we are able to put the LED chip 1 at the focal point of the parabolic reflector and weld it on two legs. We must inject transparent epoxy to cover the LED chip and the parabolic to prevent oxidizing of the chip and hold the chip strongly.

This kind parabolic LED can collect all of the light from the chip thus the intensity will be much higher than common LED. Its output is almost collimating beam, thus long distance illumination can be realized. Although its size and weight are larger than common LED, it is still small and light enough for many applications. By putting the chip not exactly on the focal point, we are able to control the divergent angle of the beam.

For the parabolic LED or common LED, we can use visible or invisible chip. During the peaceful time, we will use visible LEDs (blue, green, yellow, red, white, etc.) because their intensities are high. During the war time, we will use near infrared LED at wavelengths of 0.88μ or 0.94μ to match the peak wavelength of Low Light Level (LLL) CCD, and it is more safe during the combat because the enemy can not see the LED light by their unaided eyes.

(b) Combination Design of Visible and Invisible LEDs

The design of the combination of visible and invisible LEDs including parabolic LEDs is shown in FIG. 5.3. The visible LED chip 1 and invisible LED chip 2 are welded together oppositely inside an epoxy head. They use common positive pole of the battery 3. A knife switch 4 is used to connect the visible or invisible LED chip to the negative pole of the power supply, so visible or invisible LED light can be obtained. This kind dual-chip LED will give us great convenience.

What is claimed is:

1. A multi-color LED flashlight comprising a plurality of LED filaments with different colors combined into one LED bulb with means to select different colors and give different signals.

2. A multi-color LED flashlight according to claim 1, in which there are five LED filaments which are red, yellow, green, blue, and white LED chips (filaments) in one bulb, connected to an IC, or a rotational switch, or 5 buttons.

3. A multi-color LED flashlight according to claim 2, with a rotational head or rotational switch for color selection and another button for signaling.

4. A multi-color LED flashlight according to claim 3, with a rotational head or rotational switch for color selection and another button for signaling.

5. A multi-color LED flashlight according to claim 4, wherein the button has 3 positions: push to the upper position to hold light, push to the middle position to select color or give signal, and push to the lower position to shut down the power.

6. An arrangement having LEDs with different colors for Exit Signs.

7. An arrangement according to claims 6, having LED chips and epoxy drops directly on a circuit board to make wide angle LEDs, and coated with a reflection layer on the board to collect the back forward light.

8. A lamp having LEDs with different colors, wherein the lamp has a bowl shape with LEDs on the face and an electronic circuit board inside the bowl, and the bowl does not have a transparent or diffused cover.

9. A lamp according to claim 8, with a circuit board which can use a transformer, wwitching power supply, or resistor and capacitor to reduce voltage and change AC power to DC power.

10. A lamp according to claim 9, wherein the lamp has a common screw type head to be screwed into the common socket with AC or DC power supply.

11. A lamp according to claim 10, wherein there are n LEDs in serial on one row and m rows in parallel on the LED lamp panel, so that if several LEDs or rows are damaged, the lamp will be still lighted properly

12. A traffic light having red, yellow, and green LEDs, wherein the traffic light lamp has a bowl shape with the LEDs on the face and an electronic power circuit board inside the bowl, with the bowl having a plastic magnifier cover with UV and IR coatings to let the LED light fulfill the enclosure cover lens and filter out the UV and IR radiation from the sun.

13. A traffic light according to claim 12, wherein the power circuit is a switching power circuit that having a high power factor, low harmonic distortion and large voltage fluctuation tolerance.

14. Parabolic LEDs and combination LEDs, in which a LED chip is at the focal point of a parabolic reflector with diameter of several or several ten millimeters, so that 5 times higher intensity and 10 times longer illuminating distance than common LED can be realized.

15. An arrangement according to claim 14, in which the LED chip is covered by epoxy, and two legs are connected to a DC power supply or battery.

16. An arrangement according to claim 15, in which different color chips are used.

17. An arrangement according to claim 15, in which by putting the chip not exactly on the focal point, the divergent angle of the LED beam can be changed.

18. An arrangement according to claim 15, in which two different LED chips,(such as visible and invisible) can be combined together back to back and put into one epoxy head, so that by properly connecting them to a battery and using a switch, two LRDs can be lighted alternatively.

19. An arrangement according to claim 15, in which several LEDs are used to make a search light.
